(19) United States
(12) Patent Application Publication
(10) Pub. No.: US 2026/0041112 A1
(43) Pub. Date: Feb. 12, 2026

(54) FREEZE DRIED COMPOSITION COMPRISING HIGH CAFFEINE CONTENT, READY TO CONSUME FOOD PRODUCTS AND PROCESSES FOR THEIR PREPARATION

(71) Applicant: VITALMELT LTD., Petah Tikva (IL)

(72) Inventor: David KLIGER, Ramat Gan (IL)

(21) Appl. No.: 18/997,502

(22) PCT Filed: Jul. 23, 2023
(86) PCT No.: PCT/IL2023/050763

§ 371 Date: Jan. 21, 2025

Related U.S. Application Data
(60) Provisional application No. 63/394,050, filed on Aug. 1, 2022.

(51) Int. Cl. A23F 5/40; A23F 5/32; A23F 5/46

(52) U.S. Cl. CPC A23F 5/40; A23F 5/32; A23F 5/405; A23F 5/465

(57) ABSTRACT

The present invention provides a freeze-dried dairy compositions and preparation thereof that melts in the mouth including about 1-10% w/w of at least one non-dairy beverage component, about 10-40% w/w of at least one high fat dairy beverage component, about 1-20% w/w of at least one thickening component, about 10-60% w/w of at least one sweetener, at least 1% w/w exogenous caffeine, and less than 5% w/w water.

### TECHNOLOGICAL FIELD

The present invention provides a freeze-dried solid food product comprising high caffeine content that is ready to be consumed by directly introducing to the mouth and processes for preparation thereof.

### BACKGROUND

Some beverages are consumed by subjects for providing hydration as well nutritional elements and other beneficial short-term effects. For example, many people drink coffee for the stimulant effect of its caffeine content. However, on many occasions during a productive working day or while performing other tasks, it is not possible to consume liquid beverages, particularly those that require preparation, for example brewing, boiling, or mixing of the beverage ingredients.

Thus, there is a need for a food product that can provide on the one hand the required nutrients and elements of a beverage, but on the other hand does not necessitate the need to prepare said beverage. In particular, there is a need for a product that represents a solid form of the beverage that does not require water for its consumption, i.e., ready for eating without any means of preparation. Such a need is solved by the present invention by providing a ready to consume food product that comprises said beverage in an edible form. Such a product can be consumed by a subject while performing other tasks.

Therefore, there is still a need for a food product which can satisfy a person's desire for a creamy high caffeine snack while on the go.

### SUMMARY

According to some embodiments, provided herein are advantageous freeze-dried solid dairy composition in a product form that can instantly melt in the mouth of a subject, wherein dairy composition comprises a high caffeine content.

In some embodiments, the present invention provides a freeze-dried dairy composition including about 1-10% w/w of at least one non-dairy beverage component, about 10-40% w/w of at least one dairy beverage component, about 1-20% w/w of at least one thickening component, about 10-60% w/w of at least one sweetener, wherein the freeze-dried dairy composition is freeze-dried to obtain a ready to be consumed product form which melts in the mouth.

According to some embodiments, due to the product being capable of melting in the mouth, the hereindisclosed compositions may be used and/or consumed by a wide range of subjects, including, healthy subjects, and subjects afflicted with a disease or condition, in particular, conditions which affect appetite, eating and/or swallowing.

Additionally, according to some embodiments the dairy composition of the present invention does not have to be further prepared in any manner. It does not have to be cooked, rehydrated, steamed, mixed with a liquid (hot or cold), fried, microwaved or any other form of preparation. A product of the present invention is ready to be consumed by a subject as is, without any other additions or preparations. Thus, the dairy composition of the present invention is readily consumed while performing other tasks such as working, driving, walking, etc.

According to some embodiments, the composition is a solid porous matrix (non-powdered). According to some embodiments, the composition may have the form of a single bite. According to some embodiments, the volume of the single bite may be at least about 4 cm³, at least about 5 cm³, at least about 6 cm³, or at least about 8 cm³. Each possibility is a separate embodiment. According to some embodiments, the volume of the single bite may be between about 4 cm³ and about 8 cm³ or about 4 cm³ and about 6 cm³. Each possibility is a separate embodiment.

According to some embodiments, the composition may comprise less than about 5% w/w water after freeze drying.

According to some embodiments, the composition may comprise at least one non-dairy beverage component. In some embodiments, the amount of non-dairy beverage component may be present in the range between about 35-85% w/w, about 40-80% w/w, about 40-65% w/w, about 50-70% w/w, or about 55-65% w/w, prior to drying. Each possibility is a separate embodiment. In some embodiments, the amount of non-dairy beverage component may be present in an amount at least about 1% w/w, at least about 2% w/w, at least about 3% w/w, at least about 4% w/w, at least about 5% w/w, at least about 10% w/w, at least about 15% w/w, at least about 20% w/w, at least about 25% w/w, at least about 30% w/w, at least about 35% w/w, at least about 40% w/w, at least about 50% w/w, at least about 60% w/w, of the dry composition. Each possibility is a separate embodiment. In some embodiments, the at least one non-dairy beverage component may be selected from coffee, tea, fruit juice, soy milk, almond milk, chocolate drink, cacao powder, pop-soda, pop-soda syrup, energy drink, energy drink syrup, protein shake, alcoholic beverage, isotonic powder or syrup, other beverages and any combinations thereof. Each possibility is a separate embodiment. According to some embodiments, the non-dairy beverage component may be organic. According to some embodiments, non-dairy beverage component may comprise caffeine. According to some embodiments, the caffeine in the non-dairy beverage component may be a natural part of the non-dairy beverage component.

According to some embodiments, the non-dairy beverage component may be coffee.

According to some embodiments, the composition may comprise a high caffeine content. In some embodiments, the composition may comprise caffeine in an amount ranging between about 35-120 mg and/or in an amount ranging between about 50-100 mg and/or in an amount ranging between about 70-80 mg. In some embodiments, the composition may comprise at least about 1% w/w, at least about 1.5% w/w, at least about 2% w/w, at least about 2.5% w/w, at least about 3% w/w, at least about 3.5% w/w, at least about 5% w/w caffeine, after freeze drying. Each possibility is a separate embodiment.

According to some embodiments, at least a portion of the caffeine may be isolated caffeine. According to some embodiments, at least a portion caffeine may be from a source different than the non-dairy beverage component, e.g., coffee, tea, etc. According to some embodiments, at least a portion caffeine may be exogenous. According to some embodiments, the caffeine may from a natural source. According to some embodiments, the caffeine may from an organic source.

According to some embodiments, at least a portion of the exogenous caffeine may be encapsulated. According to some embodiments, all the exogenous caffeine may be encapsulated. Encapsulation of the exogenous caffeine may advantageously ensure a gradual and/or prolonged release of the caffeine. According to some embodiments, an initial caffeine boost may be obtained from the non-dairy beverage component, e.g., within 1 min, 30 seconds, 20 seconds or 10 seconds after consumption. Each possibility is a separate embodiment.

According to some embodiments, caffeine may be released from the encapsulated caffeine source after the initial boost, e.g., 5 minutes, 10 minutes, 15 minutes, or 30 minutes after the initial boost. According to some embodiments, the encapsulated caffeine may be released gradually over a period of 1 hour, 2 hours or 5 hours after consumption of the composition.

According to some embodiments, the capsules may be microcapsules having a diameter of about 1-about 1,000 μm, from about 1-about 500 μm, about 1-about 250 μm, about 5-about 250 μm, or any other range within the about 1-about 1,000 μm range. Each possibility is a separate embodiment. According to some embodiments, the capsules may be nanocapsules having a diameter of less than 1 micron, e.g., about 10-about 999 nm, about 10-about 500 nm, about 10-about 250 nm, about 100-about 250 nm, or any other range within the about 10-999 nm range. Each possibility is a separate embodiment.

According to some embodiments, the capsules may be coated by a functional coating, e.g., a slow release coating, delayed release coating, rapid release coating, immediate release coating, controlled release coating, enteric coating, etc. Each possibility is a separate embodiment.

According to some embodiments, the composition may comprise at least one dairy beverage component. In some embodiments, at least one dairy component may be present in an amount ranging between about 10-80% w/w, about 15-50% w/w, about 15-25% w/w, about 20-40%, prior to freeze drying. Each possibility is a separate embodiment. In some embodiments, at least one dairy component may be present in an amount of at least about 5% w/w, at least about 10% w/w, at least about 15% w/w, at least about 20% w/w, at least about 25% w/w, at least about 30% w/w, at least about 35% w/w, at least about 40% w/w, at least about 45% w/w, at least about 50% w/w, of the freeze-dried composition. Each possibility is a separate embodiment. In some embodiments, the dairy component may have a high fat content, preferably above 12% w/w, above 18% w/w, above 22% w/w, above 30% w/w or above 40% w/w. According to some embodiments, at least one dairy beverage component may be organic.

According to some embodiments, the dairy component may be low lactose, or essentially lactose free.

According to some embodiments, the composition may comprise at least one thickening component. In some embodiments, at least one thickening component may be present in an amount ranging between about 1-35% w/w, about 2-17% w/w, about 2-12% w/w, about 3-9% w/w, or about 4-7% w/w, prior to freeze drying. Each possibility is a separate embodiment. In some embodiments, the at least one thickening component may be present in an amount of at least about 1% w/w, at least about 2% w/w, at least about 3% w/w, at least about 4% w/w, at least about 5% w/w, at least about 6% w/w, at least about 7.5% w/w, at least about 10% w/w, at least about 12.5% w/w, at least about 15% w/w, at least about 17.5% w/w, at least about 20% w/w, at least about 25% w/w, at least about 30% w/w, of the freeze-dried composition. Each possibility is a separate embodiment. In some embodiments, the at least one thickening component may be selected from a monosaccharide, oligosaccharide (for example disaccharides, like sugar), polysaccharide (for example starch, which can be either native, non-native, modified or processed starch and any combinations thereof) or any combinations thereof. Each possibility is a separate embodiment. According to some embodiments, at least one thickening component may be organic.

In other embodiments, said at least one thickening component is starch. In yet further embodiments, said at least one thickening component is a mixture of starch and sugar.

In some embodiments, the composition may comprise at least one sweetener. In some embodiments, the sweetener may be present in an amount ranging between about 5-80% w/w, about 10-60% w/w, about 20-50% w/w, about 25-50% w/w, about 5-30% w/w, about 7.5-20% w/w, prior to freeze drying. Each possibility is a separate embodiment. In some embodiments, the sweetener may be present in an amount of at least about 5% w/w, at least about 10% w/w, at least about 15% w/w, at least about 20% w/w, at least about 25% w/w, at least about 30% w/w, at least about 35% w/w, at least about 40% w/w, at least about 45% w/w, at least about 50% w/w, at least about 55% w/w, at least about 60% w/w, of the freeze-dried composition. Each possibility is a separate embodiment. In some embodiments, at least one sweetener may be selected from the group consisting of sugar, sugar substitutes, fructose, galactose, sucrose, and any combinations thereof. Each possibility is a separate embodiment. According to some embodiments, at least one sweetener may be organic.

In some embodiments, the composition may comprise at least one flavoring agent. According to some embodiments, at least one flavoring agent may be organic.

According to some embodiments, the flavoring agent may be table salt.

In some embodiments, the composition may comprise chips. In some embodiments, the chips may be selected from crushed coffee beans, cacao nibs, chocolate chips, nuts, biscuit, popped rice, fruit, seeds, shredded coconut, or any combination thereof. Each possibility is a separate embodiment. According to some embodiments, the chips may be organic.

In some embodiments, the composition may comprise a coating. In some embodiments, the coating may be selected from chocolate, coffee extract, toffee, candy, cake, shredded coconut, crushed coffee beans, cacao nibs, chocolate chips, nuts, biscuit, popped rice, fruit puree, or any combination thereof. Each possibility is a separate embodiment. According to some embodiments, the coating may be organic.

In some embodiments, the composition may comprise at least one food supplement. In some embodiments, the food supplement may be selected from include vitamins, minerals, herbs or other botanicals, such as sprouts (including, wheat sprouts, lentil sprouts, barley sprouts, fenugreek sprouts, curcumin sprouts, mung bean), amino acids, proteins, substances such as enzymes, organ tissues, glandular, metabolites, fungi, collagen, hyaluronic acid, caffeine, probiotics, probiotic bacteria, dietary fibers, dietary supplements, minerals, or any combination thereof. Each possibility is a separate embodiment. According to some embodiments, the at least one food supplement may be organic.

According to some embodiments, the composition may further include an additional additive, such as a natural preservative, an oxidating agent, an emulsifier or other food grade agent optimizing the structure, chewability, meltability, preservation or other feature and/or characteristic of the composition. According to some embodiments, such an additional additive may be organic.

According to some embodiments, a process for the preparation of a freeze-dried dairy composition the process comprises the steps of:
preparing a liquid composition comprising 40-80% w/w coffee, 10-30% w/w of at least one high fat dairy component, 1-3% w/w caffeine, 1-10% w/w of at least one thickening component and 5-30% w/w at least one sweetener; and
freeze drying said liquid composition until water content is less than about 5% weight of the product; thereby producing a freeze-dried dairy composition having a ready to be consumed product form, which melts in the mouth.

In some embodiments, a process for the preparation of a freeze-dried dairy composition the process may comprising the steps of:
(a) preparing about 40-85% w/w of at least one non-dairy beverage component;
(b) mixing said non-dairy food component with about 10-30% w/w of at least one dairy component, wherein the mixing us performed at a temperature of below 75° C.;
(c) adding about 1-10% w/w at least one thickening component;
(d) sweetening with about 5-30% w/w at least one sweetener; and
(e) freeze drying said mixture until water content is less than 5% weight of the product; thereby producing a freeze-dried dairy composition having a ready to be consumed product form, which melts in the mouth.

In some embodiments, the process may further comprise adding chips to said dairy composition prior to freeze drying.

In some embodiments, the process may further comprise coating the freeze-dried dairy composition after freeze drying.

In some embodiments, the process may further comprise adding at least one food supplement to said dairy composition prior to freeze drying.

In some embodiments, the process may further comprise casting said liquid composition into a mold prior to freeze drying.

Certain embodiments of the present disclosure may include some, all, or none of the above advantages. One or more technical advantages may be readily apparent to those skilled in the art from the figures, descriptions and claims included herein. Moreover, while specific advantages have been enumerated above, various embodiments may include all, some or none of the enumerated advantages.

In addition to the exemplary aspects and embodiments described above, further aspects and embodiments will become apparent by reference to the figures and by study of the following detailed descriptions.

### BRIEF DESCRIPTION OF THE FIGURES

The invention will now be described in relation to certain examples and embodiments with reference to the following illustrative figures so that it may be more fully understood.

FIG. 1 is a flowchart of steps in a process of preparing a freeze-dried dairy composition, according to some embodiments.

FIG. 2 is an illustrative photograph of a freeze-dried single dose composition, according to some embodiments.

FIG. 3 is an illustrative photograph of a freeze-dried single dose dairy composition, according to some embodiments.

FIG. 4 is an illustrative photograph of a freeze-dried single dose dairy composition containing chips, according to some embodiments.

FIG. 5 is an illustrative photograph of a chocolate coated freeze-dried single dose dairy composition, according to some embodiments.

### DETAILED DESCRIPTION OF EMBODIMENTS

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure.

In some embodiments, the present invention provides a freeze-dried dairy composition including at least one non-dairy beverage component, at least one dairy beverage component, at least one thickening component, at least one sweetener, wherein the freeze-dried dairy composition is freeze-dried to obtain a ready to be consumed product form which melts in the mouth. According to some embodiments, at least one component of the freeze-dried dairy composition may be organic.

It is further defined that the composition of the present invention is “freeze-dried”, also known as “lyophilization” and “cryodesiccation” resulting in a chewable and/or meltable solid form. As used herein, according to some embodiments, the term “freeze drying” may refer to a low temperature dehydration process that involves freezing the product, lowering pressure, followed by a removing of ice by sublimation. This is in contrast to dehydration by most conventional methods that evaporate water using heat.

Additionally, composition of the present invention is defined to be a “ready to be consumed product”, thus it does not have to be further prepared in any manner. It does not have to be cooked, rehydrated, steamed, mixed with a liquid (hot or cold), fried, microwaved or any other form of preparation.

According to some embodiments, as used herein, the term “organic” may refer to a component produced, grown or farmed using, while complying with the standards of organic farming. Standards vary worldwide, but organic farming features practices that cycle resources, promote ecological balance, and conserve biodiversity. Organizations regulating organic products may restrict the use of certain pesticides and fertilizers in the farming methods used to produce such products. Organic foods are typically not processed using irradiation, industrial solvents, or synthetic food additives.

According to some embodiments, provided herein are advantageous freeze-dried solid dairy composition in a product form that can instantly melt in the mouth of a subject, wherein dairy composition comprises a high caffeine content.

The term “at least one non-dairy beverage component” should be understood to encompass a component that is typically a liquid beverage, usually consumed by drinking (hot or cold) that does not include any dairy element. It is noted that a food product of the present invention, thus provides said at least one non-dairy beverage in a chewable solid form as the final product ready to be consumed. Further, it is noted that said at least one non-dairy beverage component is formed into said solid chewable ready to consume food product from a liquid form.

As a further advantage, as further exemplified herein, the dairy composition is devoid of synthetic preservatives and all ingredients thereof are 100% natural. As an additional advantage, the dairy composition is composed, at least in part, of organic components.

According to some embodiments, due to the product being capable of melting in the mouth, the hereindisclosed compositions may be used and/or consumed by a wide range of subjects, including, healthy subjects, and subjects afflicted with a disease or condition, in particular, conditions which affect appetite, eating or swallowing.

Additionally, according to some embodiments the dairy composition of the present invention does not have to be further prepared in any manner. It does not have to be cooked, rehydrated, steamed, mixed with a liquid (hot or cold), fried, microwaved or any other form of preparation. A product of the present invention is ready to be consumed by a subject as is, without any other additions or preparations. Thus, the dairy composition of the present invention is readily consumed while performing other tasks such as working, driving, walking, etc.

According to some embodiments, the composition is a solid porous matrix (non-powdered). According to some embodiments, the composition may have the form of a single bite. According to some embodiments, the volume of the single bite may be at least about 4 cm³, at least about 5 cm³, at least about 6 cm³, or at least about 8 cm³. Each possibility is a separate embodiment. According to some embodiments, the volume of the single bite may be between about 4 cm³ and about 8 cm³ or about 4 cm³ and about 6 cm³. Each possibility is a separate embodiment.

According to some embodiments, the composition may comprise less than about 5% w/w, less than about 2% w/w, or less than about 1% w/w water. Each possibility is a separate embodiment. The term “less than about 5% w/w of water” should be understood to relate to the amount of water present in the final food product of the invention. Since the food product of the invention is solid and chewable and/or meltable, the amount of hydration in the product to be consumed may be reduced to less than about 5% w/w, less than about 2% w/w, or less than about 1% w/w water of the product after freeze drying.

According to some embodiments, the composition includes between about 1% w/w to about 5% w/w of water. In some embodiments, the composition includes less than about 1% w/w, less than about 2% w/w, includes less than about 3% w/w, includes less than about 4% w/w, includes less than about 5% w/w, includes less than about 10% w/w of water after freeze drying. Each possibility is a separate embodiment.

According to some embodiments, the composition may comprise at least one non-dairy beverage component. In some embodiments, the amount of non-dairy beverage component may be present in the range between about 35-85% w/w, about 40-80% w/w, about 50-70% w/w, or about 55-65% w/w, prior to drying. Each possibility is a separate embodiment. In some embodiments, the amount of non-dairy beverage component may be present in an amount at least about 1% w/w, at least about 2% w/w, at least about 3% w/w, at least about 4% w/w, at least about 5% w/w, at least about 10% w/w, at least about 15% w/w, at least about 20% w/w, at least about 25% w/w, at least about 30% w/w, at least about 35% w/w, at least about 40% w/w, at least about 50% w/w, at least about 60% w/w, of the dry composition. Each possibility is a separate embodiment. In some embodiments, the at least one non-dairy beverage component may be selected from coffee, tea, fruit juice, soy milk, almond milk, chocolate drink, cacao powder, pop-soda, pop-soda syrup, energy drink, energy drink syrup, protein shake, alcoholic beverage, isotonic powder or syrup, other beverages and any combinations thereof. Each possibility is a separate embodiment. According to some embodiments, the non-dairy beverage component may be organic.

According to some embodiments, the non-dairy beverage component may be coffee. In some embodiments, a coffee extract may be produced from coffee beans and water. In some embodiments, the ratio between the coffee beans and water may be 1:5, 1:4, 1:3, 1:2, 1:1, 2:1, 3:1, 4:1, 5:1. Each possibility is a separate embodiment. According to some embodiments, the coffee may be organic. According to some embodiments, the caffeine in the non-dairy beverage component may be a natural part of the non-dairy beverage component.

According to some embodiments, the composition may comprise a high caffeine content. In some embodiments, the composition may comprise caffeine in an amount ranging between about 35-120 mg, between about 50-100 mg, or between about 70-80 mg. Each possibility is a separate embodiment. In some embodiments, the composition may comprise at least about 1% w/w, at least about 1.5% w/w, at least about 2% w/w, at least about 2.5% w/w, at least about 3% w/w, at least about 3.5% w/w, at least about 5% w/w caffeine. Each possibility is a separate embodiment.

According to some embodiments, additional exogenous caffeine may be added to the composition. In some embodiments, the additional exogenous caffeine may comprise at least about 1% w/w, at least about 1.5% w/w, at least about 2% w/w, at least about 2.5% w/w, at least about 3% w/w, at least about 3.5% w/w, at least about 5% w/w caffeine. Each possibility is a separate embodiment. According to some embodiments, the caffeine may be from an organic source.

According to some embodiments, at least a portion of the exogenous caffeine may be encapsulated. According to some embodiments, all the exogenous caffeine may be encapsulated. Encapsulation of the exogenous caffeine may advantageously ensure a gradual and/or prolonged release of the caffeine. According to some embodiments, an initial caffeine boost may be obtained from the non-dairy beverage component, e.g., within 1 min, 30 seconds, 20 seconds, or 10 seconds after consumption. Each possibility is a separate embodiment.

According to some embodiments, caffeine may be released from the encapsulated caffeine source after the initial boost, e.g., 5 minutes, 10 minutes, 15 minutes, or 30 minutes after the initial boost. According to some embodiments, the encapsulated caffeine may be released gradually over a period of 1 hour, 2 hours or 5 hours after consumption of the composition.

According to some embodiments, the capsules may be microcapsules having a diameter of about 1-about 1000 μm, from about 1-about 500 μm, about 1-about 250 μm, about 5-about 250 μm, or any other range within the about 1-about 1000 μm range. Each possibility is a separate embodiment. According to some embodiments, the capsules may be nanocapsules having a diameter of less than 1 micron, e.g., about 10-about 999 nm, about 10-about 500 nm, about 10-about 250 nm, about 100-about 250 nm, or any other range within the about 10-999 nm range. Each possibility is a separate embodiment.

According to some embodiments, the capsules may be coated by a functional coating, e.g., a slow release coating, delayed release coating, rapid release coating, immediate release coating, controlled release coating, enteric coating, etc. Each possibility is a separate embodiment.

According to some embodiments, the composition may comprise at least one dairy beverage component. In some embodiments, at least one dairy component may be present in an amount ranging between about 10-80% w/w, about 15-50% w/w, about 15-25% w/w, about 20-40%, prior to freeze drying. Each possibility is a separate embodiment. In some embodiments, the at least one dairy component may be present in an amount of at least about 5% w/w, at least about 10% w/w, at least about 15% w/w, at least about 20% w/w, at least about 25% w/w, at least about 30% w/w, at least about 35% w/w, at least about 40% w/w, at least about 45% w/w, at least about 50% w/w, of the freeze-dried composition. Each possibility is a separate embodiment. In some embodiments, at least one dairy component may have a high fat content. In some embodiments, the dairy component may have a fat content between about 1-80% w/w, about 1-60% w/w, about 3-50% w/w, about 7-55% w/w, about 12-40% w/w, or about 15-30% w/w. Each possibility is a separate embodiment. In some embodiments, the dairy component may have a high fat content, preferably above 12% w/w, above 18% w/w, or above 30% w/w. According to some embodiments, at least one dairy beverage component may be organic.

According to some embodiments, the dairy component may be low lactose, or essentially lactose free.

As used herein, according to some embodiments, the term “at least one thickening component” may be understood to encompass any component that is able to increase the viscosity of said at least one non-dairy beverage component without substantially changing its other properties (such as its taste and smell, for example). It is noted that at least one thickening component is formed from edible elements.

According to some embodiments, the composition may comprise at least one thickening component. In some embodiments, at least one thickening component may be present in an amount of between about 1-35% w/w, about 2-17% w/w, about 2-12% w/w, about 3-9% w/w, or about 4-7% w/w, prior to freeze drying. Each possibility is a separate embodiment. In some embodiments, the at least one thickening component may be present in an amount of at least about 1% w/w, at least about 2% w/w, at least about 3% w/w, at least about 4% w/w, at least about 5% w/w, at least about 6% w/w, at least about 7.5% w/w, at least about 10% w/w, at least about 12.5% w/w, at least about 15% w/w, at least about 17.5% w/w, at least about 20% w/w, at least about 25% w/w, at least about 30% w/w, of the freeze-dried composition. Each possibility is a separate embodiment. In some embodiments, at least one thickening component may be selected from a monosaccharide, oligosaccharide (for example disaccharides, like sugar), polysaccharide (for example starch, which can be either native, non-native, modified or processed starch and any combinations thereof) or any combinations thereof. Each possibility is a separate embodiment. According to some embodiments, at least one thickening component may be organic.

In other embodiments, said at least one thickening component is starch. In yet further embodiments, said at least one thickening component is a mixture of starch and sugar. In some embodiments, said at least one thickening component is starch selected from potato starch, tapioca starch, rice starch, corn starch, wheat starch, maze starch, cassava starch, sweet potato starch or any combinations thereof. Each possibility is a separate embodiment.

In some embodiments, the composition may comprise at least one sweetener. In some embodiments, the sweetener may be present in an amount ranging between about 5-80% w/w, about 10-60% w/w, about 20-50% w/w, about 25-50% w/w, about 5-30% w/w, about 7.5-20% w/w, prior to freeze drying. Each possibility is a separate embodiment. In some embodiments, the sweetener may be present in an amount of at least about 5% w/w, at least about 10% w/w, at least about 15% w/w, at least about 20% w/w, at least about 25% w/w, at least about 30% w/w, at least about 35% w/w, at least about 40% w/w, at least about 45% w/w, at least about 50% w/w, at least about 55% w/w, at least about 60% w/w, of the freeze-dried composition. Each possibility is a separate embodiment. In some embodiments, at least one sweetener may be selected from the group consisting of sugar, sugar substitutes, fructose, galactose, sucrose, and any combinations thereof. Each possibility is a separate embodiment. According to some embodiments, at least one sweetener may be organic.

According to some embodiments, the sweetener may be a natural sweetener. Non-limiting examples of suitable natural sweeteners include sugar, glucose, fructose, stevia, crythritol, xylitol, mannitol, agave nectar, Yacon syrup, honey, maple, molasses, coconut sugar, Monk fruit sweetener and any combination thereof. Each possibility is a separate embodiment. According to some embodiments, the sweetener may be a synthetic sweetener. Non-limiting examples of suitable natural sweeteners include aspartame, Acesulfame potassium, Advantame, Aspartame-acesulfame salt, cyclamate, neotame, ncohesperidin, saccharinie, sucralose, etc. or any combination thereof. Each possibility is a separate embodiment.

In some embodiments, the composition may comprise at least one flavoring agent. According to some embodiments, at least one flavoring agent may be organic.

It should be noted that said flavoring agent relates to any type of edible substance added to a product of the invention (at any step of product preparation) that adds and/or alters and/or intensifies the flavor of a product of the invention through the sense of taste and/or smell. In some embodiments said at least one flavoring agent is a natural flavoring substance (i.e. flavoring substances obtained from plant or animal raw materials, by physical, microbiological or enzymatic processes), a nature-identical flavoring substance (i.e. flavoring substances that are obtained by synthesis or isolated through chemical processes, which are chemically and organoleptically identical to flavoring substances naturally present in products intended for human consumption) or an artificial flavoring substance (i.e. chemically produced flavoring substances that are typically chemically different from the corresponding natural flavoring substance however, in sensory characteristics are the same as natural ones), and any combination thereof.

In some embodiments, said at least one flavoring agent is selected from the group consisting of a sweetening agent (such as a sweetening saccharide, sugar, sugar substitutes), fructose, galactose, flavoring extracts (such as spices and herb flavors, including vanilla, cinnamon, nutmeg, cardamom, etc. or combinations thereof; fruit flavors including banana, strawberry, berry, grape, orange, pineapple, lemon, etc.) or any combinations thereof. Each possibility is a separate embodiment.

According to some embodiments, the food flavoring agent may be a spice or combination of spices, such as, but not limited to: salt, pepper, garlic (for example, in the form of powder), onion (for example, in the form of powder), and the like. According to some embodiments, the food flavoring agent may be an herb or combination of dried spice herbs, such as, but not limited to: oregano, basil, thyme, coriander, parsley, rosemary, and the like. According to some embodiments, the food flavoring agent may be a fruit or combination of fruits.

According to some embodiments, the flavoring agent may be table salt.

According to some embodiments, the composition comprises at least about 0.01% w/w, at least about 0.1% w/w, at least about 0.5% w/w, at least about 1% w/w, at least about 1.5% w/w or at least about 2% w/w of table salt or other flavoring agent after freeze drying. Each possibility is a separate embodiment.

In some embodiments, the composition may comprise chips. In some embodiments, the chips may be selected from crushed coffee beans, cacao nibs, chocolate chips, nuts, biscuit, popped rice, fruit, seeds, nuts, shredded coconut, freeze-dried fruit, or any combination thereof. Each possibility is a separate embodiment. According to some embodiments, the chips may be organic. In some embodiments, the chips may be present in the composition in an amount ranging between about 0.1-5 g, about 0.25-3 g, or about 0.75-2 g per serving. Each possibility is a separate embodiment.

In some embodiments, the composition may comprise a coating. In some embodiments, the coating may be selected from chocolate, coffee extract, toffee, candy, cake, shredded coconut, crushed coffee beans, cacao nibs, chocolate chips, nuts, biscuit, popped rice, fruit puree, or any combination thereof. Each possibility is a separate embodiment. According to some embodiments, the coating may be organic. According to some embodiments, the chocolate coating may comprise at least 30% w/w, at least 40% w/w, at least 50% w/w, at least 60% w/w, at least 70% w/w, at least 80% w/w cocoa. In some embodiments, the coating may comprise cocoa butter. Each possibility is a separate embodiment.

In some embodiments, the composition may comprise at least one food supplement. In some embodiments, the food supplement may be selected from include vitamins, minerals, herbs or other botanicals, such as sprouts (including, wheat sprouts, lentil sprouts, barley sprouts, fenugreek sprouts, curcumin sprouts, mung bean), amino acids, proteins, substances such as enzymes, organ tissues, glandular, metabolites, fungi, collagen, hyaluronic acid, caffeine, probiotics, probiotic bacteria, dietary fibers, dietary supplements, minerals, or any combination thereof. Each possibility is a separate embodiment. According to some embodiments, at least one food supplement may be organic.

In some embodiments, the food supplement may be selected from may include one or more of vitamin A (as all-trans-retinol, all-trans-retinyl-esters, as well as all-trans-beta-carotene and other provitamin A carotenoids), vitamin B₁ (thiamine (such as, Thiamine Hydrochloride), vitamin B₂ (riboflavin), vitamin B₃ (niacin), vitamin B₅ (pantothenic acid), vitamin B₆ (pyridoxine), vitamin B₇ (biotin), vitamin B₉ (folic acid or folate), vitamin B₁₂ (cobalamins (such as cyanocobalamin), vitamin C (ascorbic acid), vitamin D (calciferols (such as, D3)), vitamin E (tocopherols and tocotrienols (such as a-tocopherol acetate)), vitamin K (phylloquinone and menaquinones), Zinc, Magnesium (Mg in various forms), Calcium, Copper, Selenium and Iron. Each possibility is a separate embodiment. In some embodiments, the food supplement may be caffeine.

According to some embodiments, the composition may further include an additional additive, such as a natural preservative, an oxidating agent, an emulsifier, or other food grade agent optimizing the structure, chewability, meltability, preservation or other feature and/or characteristic of the composition. According to some embodiments, such an additional additive may be organic.

According to some embodiments, the total fat content of a single serving of a freeze-dried dairy composition is in the range between about 15-90% w/w, between about 20-80% w/w, between about 25-70% w/w, between about 30-60% w/w, between about 40-50% w/w of the composition. Preferably, the total fat content of a single serving of a freeze-dried dairy composition is in the range between about 30-40% w/w. Each possibility is a separate embodiment.

According to some embodiments, the saturated fat content of a single serving of a freeze-dried dairy composition is in the range between about 15-90% w/w, between about 20-80% w/w, between about 25-70% w/w, between about 30-60% w/w, between about 40-50% w/w of the composition. Preferably, the saturated fat content of a single serving of a freeze-dried dairy composition is in the range between about 20-30% w/w. Each possibility is a separate embodiment.

According to some embodiments, the total carbohydrate content of a single serving of a freeze-dried dairy composition is in the range between about 15-90% w/w, between about 20-80% w/w, between about 25-70% w/w, between about 30-60% w/w, between about 40-50% w/w of the composition. Preferably, the total carbohydrate content of a single serving of a freeze-dried dairy composition is in the range between about 45-55% w/w. Each possibility is a separate embodiment.

According to some embodiments, the total sugar content of a single serving of a freeze-dried dairy composition is in the range between about 15-90% w/w, between about 20-80% w/w, between about 25-70% w/w, between about 30-60% w/w, between about 40-50% w/w of the composition. Preferably, the total sugar content of a single serving of a freeze-dried dairy composition is in the range between about 45-55% w/w. Each possibility is a separate embodiment.

According to some embodiments, the amount of added sugar in a single serving of a freeze-dried dairy composition is in the range between about 15-90% w/w, between about 20-80% w/w, between about 25-70% w/w, between about 30-60% w/w, between about 40-50% w/w of the composition. Preferably, the amount of added sugar in a single serving of a freeze-dried dairy composition is in the range between about 20-30% w/w. Each possibility is a separate embodiment.

According to some embodiments, the cholesterol content of a single serving of a freeze-dried dairy composition is in the range between about 0.01-1% w/w, between about 0.05-0.75% w/w, between about 0.1-0.5% w/w of the composition. Preferably, the total carbohydrate content of a single serving of a freeze-dried dairy composition is in the range between about 0.1-0.2% w/w. Each possibility is a separate embodiment.

According to some embodiments, a process for the preparation of a freeze-dried dairy composition the process comprises the steps of:
preparing a liquid composition comprising 40-80% w/w coffee, 10-30% w/w of at least one high fat dairy component, 1-3% w/w caffeine, 1-10% w/w of at least one thickening component and 5-30% w/w at least one sweetener; and
freeze drying said liquid composition until water content is less than about 5% weight of the product; thereby producing a freeze-dried dairy composition having a ready to be consumed product form, which melts in the mouth.

In some embodiments, a process for the preparation of a freeze-dried dairy composition the process may comprising the steps of:
preparing a liquid composition comprising:
(a) mixing 40-80% w/w non-dairy food component with about 10-30% w/w of at least one dairy component, wherein the mixing is performed at a temperature of below 75° C.;
(b) adding about 1-10% w/w at least one thickening component;
(c) sweetening with about 5-30% w/w at least one sweetener; and
   preparing a freeze-dried dairy composition by freeze drying said liquid composition until water content is less than 5% w/w; wherein the freeze-dried dairy composition is a ready to be consumed product, which melts in the mouth.

In some embodiments, the process may further comprise adding chips to said liquid composition.

In some embodiments, the process may further comprise coating the freeze-dried dairy composition after freeze drying.

In some embodiments, the process may further comprise adding at least one food supplement to the liquid composition.

In some embodiments, the process may further comprise casting the liquid composition into a mold prior to freeze drying.

In some embodiments, a dairy composition of the invention may have a mechanical compressibility of at least about 5 N/cm² or about 50 KPa. In some embodiments, a dairy composition of the invention has a mechanical compressibility in the range of between about 5 N/cm² and about 20 N/cm².

In some embodiments, a dairy composition of the invention has a density of at least about 120 mg/cm³. In some embodiments, a dairy composition of the invention has a density in the range of between about 120 mg/cm³ and about 500 mg/cm³.

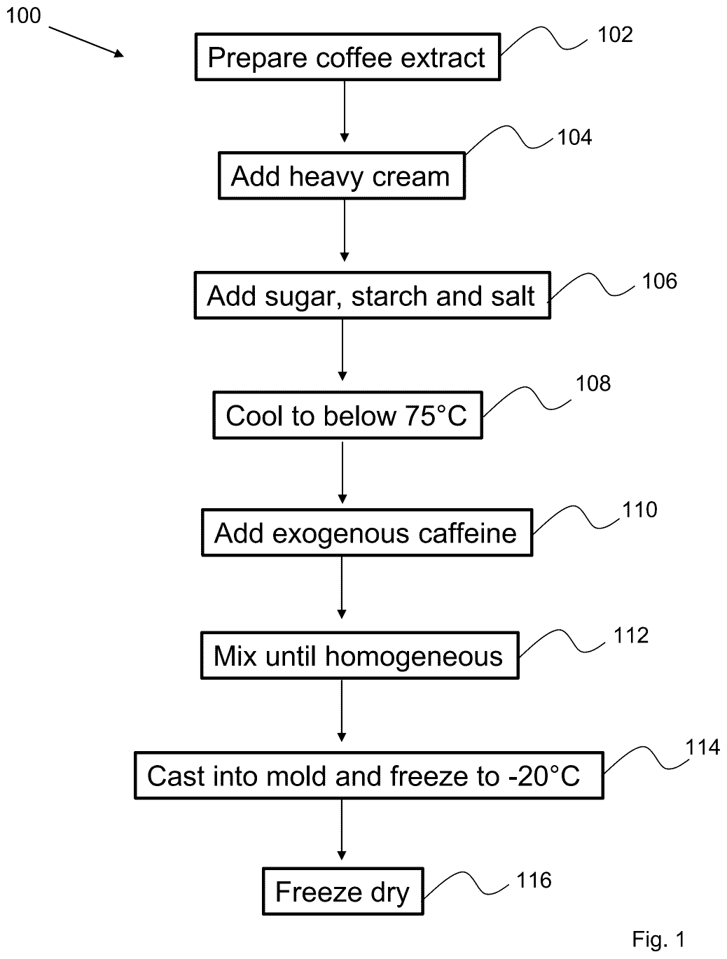

According to some embodiments, there is provided a process for the preparation of a freeze-dried coffee composition as disclosed herein. Reference is now made to FIG. 1, which shows exemplary steps in the preparation process, the steps for preparing the ingredient mixture prior to freezing may be performed in any order. As shown in FIG. 1, process 100 includes at Step 102, of preparing a coffee extract from roasted coffee beans. Here, the ratio of the beans to water was 1:3.

In step 110 the coffee extract was mixed with exogenous caffeine, to a final concentration of about 1% w/w caffeine or more, at a temperature below 75° C. (step 108). According to some embodiments, the exogenous caffeine is encapsulated.

In step 104, heavy cream (e.g., 38% fat) is added to a final concentration of 10-30% w/w or more of the liquid mixture, and in step 106 sugar was added to a final concentration of 5-30% w/w of the mixture, and starch to a final concentration of 1-10% w/w of the mixture. Optionally, in step 106 and salt was added to taste. The mixture was mixed until homogeneous (step 112). In step 114 the mixture was then cast into a mold and frozen to a temperature of −20° C. In step 116 the frozen mixture was then transferred to a freeze-drying device 118 (“Cool safe superior 95-80” by Labogene), until the water level was less than 5% w/w of the final ready to consume dairy composition.

### EXAMPLES

### Example 1: Process for the Preparation of a Dairy Composition of the Present Invention

The ingredients of the composition are set forth in Table 1 below.

TABLE 1

| | Amount | % w/w | Amount | % w/w Dry |
|---|---|---|---|---|
| | wet (g) | Wet mix | dry (g) | product |
| Coffee extract | 750 | 61.9 | 15 | 4.49 |
| (1:4 Beans/Water) | | | | |
| Heavy cream 38% fat | 250 | 20.6 | 107 | 32.04 |
| Corn starch | 52 | 4.3 | 52 | 15.57 |
| Sugar | 160 | 13.2 | 160 | 47.90 |
| Total | 1212 | 100 | 334 | 100 |

A hot coffee extract was prepared from roasted coffee beans, wherein the ratio of the beans to water was 1:3. The extract was mixed with heavy cream, sugar, starch, and optionally table salt, at a temperature below 75° C. The mixture was then cast into a mold and frozen to a temperature of −20° C. The frozen mixture was then transferred to a freeze-drying device (“Cool safe superior 95-80” by Labogene), until the water level was less than 5% (weight percentage).

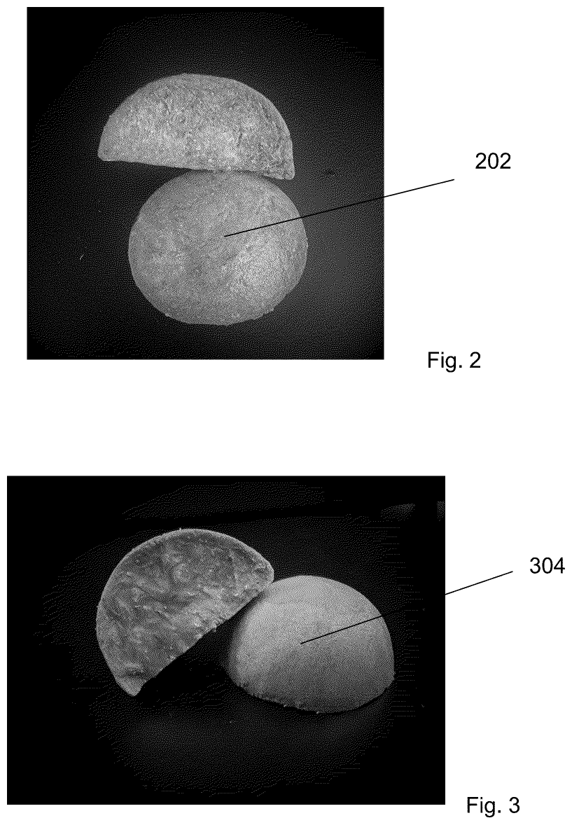

FIG. 2 is an illustrative photograph of a freeze-dried single dose dairy composition 202 made by a process similar to the above and in accordance with some embodiments of the invention. For example, the freeze-dried dairy composition 202 may be homogeneous with the exogenous caffeine dispersed uniformly throughout the composition.

### Example 2: Addition of Exogenous Caffeine

To the dairy composition of Example 1, exogenous caffeine was added to the composition to ensure that each serving contains about 75 mg of caffeine.

A hot coffee extract was prepared from roasted coffee beans, wherein the ratio of the beans to water was 1:3. The extract was mixed with exogenous caffeine, heavy cream, sugar, starch, and optionally table salt, at a temperature below 75° C. The mixture was then cast into a mold and frozen to a temperature of −20° C. The frozen mixture was then transferred to a freeze-drying device (“Cool safe superior 95-80” by Labogene), until the water level was less than 5% (weight percentage).

FIG. 3 is an illustrative photograph of a freeze-dried single dose dairy composition 302 made by a process similar to the above and in accordance with some embodiments of the invention. For example, the freeze-dried dairy composition 302 may be homogeneous, with the exogenous caffeine dispersed uniformly throughout the composition. Optionally, the composition may provide a caffeine dose equivalent to one or two cups of espresso.

### Example 3: Addition of Coffee Chips

An exemplary formulation for the ground coffee beans dairy composition may be found in Table 2.

TABLE 2

| | Amount | % w/w | Amount | % w/w Dry |
|---|---|---|---|---|
| | wet (g) | Wet mix | dry (g) | product |
| Coffee extract | 750 | 58.3 | 15 | 3.67 |
| (1:4 Beans/Water) | | | | |
| Heavy Cream 38% Fat | 250 | 19.4 | 107 | 26.16 |
| Corn Starch | 52 | 4.0 | 52 | 12.71 |
| Sugar | 160 | 12.4 | 160 | 39.12 |
| Coffee Chips | 75 | 5.83 | 75 | 18.34 |
| Total | 1287 | 100 | 409 | 100 |

Additionally, and/or alternatively, to the dairy composition of Example 1 or Example 2, ground coffee beans may be added to the composition such that each serving receives about 1 g of ground coffee beans. A hot coffee extract was prepared from roasted coffee beans, wherein the ratio of the beans to water was 1:3. The extract was mixed with ground coffee beans, heavy cream, sugar, starch, and optionally table salt, at a temperature below 75° C. The mixture was then cast into a mold and frozen to a temperature of −20° C. The frozen mixture was then transferred to a freeze-drying device (“Cool safe superior 95-80” by Labogene), until the water level was less than 5% (weight percentage).

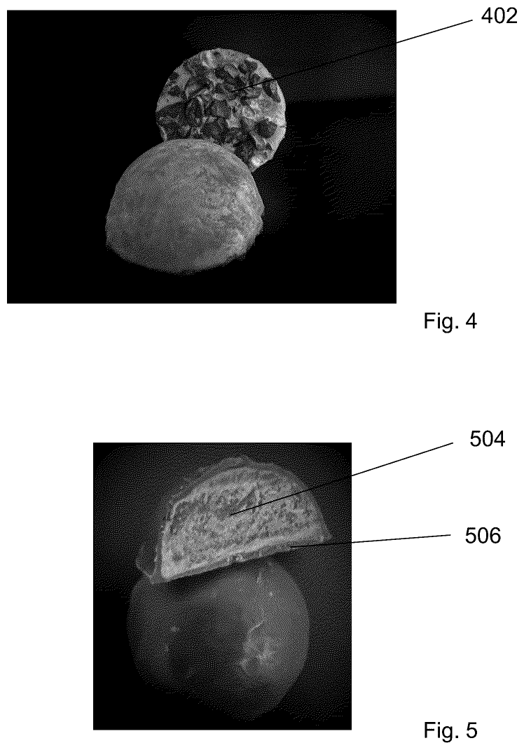

FIG. 4 is an illustrative photograph of a freeze-dried single dose dairy composition 402 containing chips made by a process similar to the above and in accordance with some embodiments of the invention. For example, the chips 402 may be crushed coffee beans. Optionally, the chips may be chocolate chips, cacao nibs, crushed coffee beans, freeze-dried fruit pieces, etc.

### Example 4: Chocolate Coating

An exemplary formulation for the chocolate coated dairy composition may be found in Table 3.

TABLE 3

| | Amount | % w/w | Amount | % w/w Dry |
|---|---|---|---|---|
| | wet (g) | Wet mix | dry (g) | product |
| Coffee extract | 750 | 45.1 | 15 | 1.91 |
| (1:4 Beans/Water) | | | | |
| Heavy cream 38% fat | 250 | 15.0 | 107 | 13.65 |
| Corn starch | 52 | 3.1 | 52 | 6.63 |
| Sugar | 160 | 9.6 | 160 | 20.41 |
| Chocolate (for | 450 | 27.08 | 450 | 57.40 |
| cover after drying) | | | | |
| Total | 1662 | 100 | 784 | 100 |

Additionally, and/or alternatively, the dairy composition of Example 1 or Example 2 may be coated with milk chocolate. A hot coffee extract was prepared from roasted coffee beans, wherein the ratio of the beans to water was 1:3. The extract was mixed with heavy cream, sugar, starch, and optionally table salt, at a temperature below 75° C. The mixture was then casted into a mold and frozen to a temperature of −20° C. The frozen mixture was then transferred to a freeze-drying device (“Cool safe superior 95-80” by Labogene), until the water level was less than 5% (weight percentage). Each serving was then dipped into molten milk chocolate and then placed in a chiller until the chocolate hardened.

FIG. 5 is an illustrative photograph of a chocolate coated freeze-dried single dose dairy composition 504 made by a process similar to the above and in accordance with some embodiments of the invention. For example, the freeze-dried dairy composition 504 may be coated with chocolate 506.

The term “homogeneous” refers to a mixture in which the composition is uniform throughout the mixture.

The term “a” and “an” refers to one or to more than one (i.e., to at least one) of the grammatical object of the article. By way of example, “an element” means one element or more than one element.

The term “about” when referring to a measurable value such as an amount, a temporal duration, and the like, is meant to encompass variations of +20% or in some instances ±10%, or in some instances ±5%, or in some instances ±1%, or in some instances ±0.1% from the specified value, as such variations are appropriate to perform the disclosed methods.

As used herein, the denotation “% w/w” refers to weight percent of the subject of the statement relative to the total weight of the dairy composition.

As used herein, “optional” or “optionally” means that the subsequently described event or circumstance does or does not occur, and that the description includes instances where said event or circumstance occurs and instances where it does not.

As used herein, the term “essentially” may refer to a deviation from a stated amount by ±1%, ±2% or ±5%. Each possibility is a separate embodiment. According to some embodiments, the term “essentially devoid of” may refer to the stated material is either entirely absent or present in a residual amount, such as less than 1%, less than 0.5% or less than 1%. Each possibility is a separate embodiment.

As used herein, the term “comprising” is synonymous with the terms “including,” “containing,” or “characterized by,” and is inclusive or open-ended i.e., does not exclude additional, unrecited elements. According to some embodiments, the term comprising may be replaced with the term may be replaced with the term “consisting of” which excludes any element, step, or ingredient not specified in the claim or with the term “consisting essentially of” which limits the scope of a claim to the specified materials or steps “and those that do not materially affect the basic and novel characteristics” of the claimed invention.

The following examples are included to demonstrate examples of certain preferred embodiments of the invention. It should be appreciated by those of skill in the art that the techniques disclosed in the examples that follow represent approaches the inventors have found function well in the practice of the invention, and thus can be considered to constitute examples of preferred modes for its practice. However, those of skill in the art should, in light of the present disclosure, appreciate that many changes can be made in the specific embodiments that are disclosed and still obtain a like or similar result without departing from the spirit and scope of the invention.

1.-22. (canceled)

23. A freeze-dried dairy composition comprising:
(a) about 1-10% w/w coffee;
(b) about 10-40% w/w of at least one high fat dairy beverage component;
(c) about 1-20% w/w of at least one thickening component; and
(d) about 10-60% w/w of at least one sweetener;
wherein the composition comprises at least 1% w/w caffeine, wherein at least a portion of the caffeine is exogenous caffeine from a source different than the coffee, and wherein the composition is a ready to be consumed freeze-dried product, which melts in the mouth.

24. The composition according to claim 23, comprising less than 5% w/w water.

25. The composition according to claim 23, containing caffeine in an amount of between about 1-5% w/w.

26. The composition according to claim 23, wherein the exogenous caffeine comprises at least 1% w/w caffeine.

27. The composition according to claim 23, wherein the exogenous caffeine is encapsulated.

28. The composition according to claim 23, wherein said at least one thickening component is starch.

29. The composition according to claim 23, wherein said at least one thickening component is a mixture of starch and sugar.

30. The composition according to claim 23, wherein said at least one sweetener is selected from the group consisting of sugar, sugar substitutes, fructose, galactose, sucrose, and any combinations thereof.

31. The composition according to claim 23, further comprising at least one flavoring agent selected from flavoring extracts, natural or artificial flavoring agents and any combinations thereof.

32. The composition according to claim 23, further comprising chips, wherein the chips are selected from crushed coffee beans, cacao nibs, chocolate chips, nuts, biscuit, popped rice, fruit, seeds, shredded coconut, or any combination thereof.

33. The composition according to claim 23, further comprising a coating, wherein the coating is selected from chocolate, coffee extract, toffee, candy, cake, shredded coconut, crushed coffee beans, cacao nibs, chocolate chips, nuts, biscuit, popped rice, fruit puree, or any combination thereof.

34. The composition according to claim 23, further comprising at least one food supplement.

35. A process for the preparation of a freeze-dried dairy composition the process comprising the steps of:
preparing a liquid composition comprising 40-80% w/w coffee, 10-30% w/w of at least one high fat dairy component, 1-3% w/w exogenous caffeine, 1-10% w/w of at least one thickening component and 5-30% w/w at least one sweetener; and
freeze drying said liquid composition until water content is less than about 5% weight of the product, thereby producing a freeze-dried dairy composition having a ready to be consumed product form, which melts in the mouth.

36. The process according to claim 35, further comprising adding coffee or chocolate chips to said dairy composition prior to freeze drying.

37. The process according to claim 35, further comprising coating the freeze-dried dairy composition after the freeze drying.

38. The process according to claim 35, further comprising adding at least one food supplement to said dairy composition prior to the freeze drying.

39. The process according to claim 35, furth comprising casting said liquid composition into a mold prior to said freeze drying.

40. The process according to claim 35, wherein the exogenous caffeine is encapsulated.

41. The process according to claim 35, wherein the freeze-dried dairy composition comprises:
about 1-10% w/w coffee;
about 10-40% w/w of at least one high fat dairy beverage component;
about 1-20% w/w of at least one thickening component; and
about 10-60% w/w of at least one sweetener.
